(19) United States
(12) Patent Application Publication
(10) Pub. No.: US 2013/0169106 A1
(43) Pub. Date: Jul. 4, 2013

(54) SINGLE-PHASE INDUCTION MOTOR

(71) Applicant: NIDEC CORPORATION, Minami-ku (JP)

(72) Inventors: Tomoyoshi YOKOGAWA, Kyoto (JP); Toshinobu SHINOHARA, Kyoto (JP); Kazuhiro UEMURA, Kyoto (JP)

(73) Assignee: NIDEC CORPORATION, Minami-ku (JP)

(21) Appl. No.: 13/707,030

(22) Filed: Dec. 6, 2012

(30) Foreign Application Priority Data
Dec. 28, 2011 (JP) 2011-287234

(51) Int. Cl. H02K 1/14

(52) U.S. Cl. CPC H02K 1/14
USPC 310/216.111

(57) ABSTRACT

A single-phase induction motor in which coils are wound around a plurality of teeth by a concentrated winding method is constructed such that an area of a smallest of all cross-sections of a core back element taken along planes which are parallel or substantially parallel to an axial direction is about 0.90 or more times an area of the smallest of all cross-sections of the teeth taken along planes which are parallel or substantially parallel to the axial direction, to prevent or minimize leakage of the magnetic flux.

### BACKGROUND OF THE INVENTION

1. Field of the Invention

The present invention relates to a motor and more specifically to a single-phase induction motor of an inner rotor type.

2. Description of the Related Art

A yoke of a stator of a conventional induction motor disclosed in JP-A 2006-288080 is a unified collection of yoke members each of which includes a tooth and which are joined to one another by a joining method such that the unified collection of the yoke members is bendable. In a situation in which the unified collection of the yoke members is expanded into a straight line, a main conducting wire is continuously wound around each of odd-numbered teeth with passage lines being defined between the odd-numbered teeth, and an auxiliary conducting wire is continuously wound around each of even-numbered teeth with passage lines defined between the even-numbered teeth. Both ends of the unified collection of the yoke members are then joined to each other to form the yoke into an annular shape.

However, in the case of a conventional stator core including a plurality of core elements which are arranged in a straight line in an expanded condition before being formed into an annular shape, the radial width of a core back is smaller than the circumferential width of each of teeth. In the case of a single-phase induction motor (also referred to as a “single-phase alternating-current motor”) of a concentrated winding type in which a coil is wound around each of teeth, the maximum magnetic flux passing through each tooth and the maximum magnetic flux passing through the core back are equal to each other in theory. Therefore, magnetic flux passing from a rotating portion to the tooth may leak out of the core back, leading to insufficient efficiency of operation of the motor.

### SUMMARY OF THE INVENTION

Preferred embodiments of the present invention have been conceived primarily to prevent or minimize a decrease in efficiency of operation of a single-phase induction motor including a main conducting wire and an auxiliary conducting wire.

A single-phase induction motor according to a preferred embodiment of the present invention includes a rotating portion, a stationary portion including a stator, and a bearing portion. The bearing portion is arranged to support the rotating portion such that the rotating portion is rotatable about a central axis with respect to the stationary portion. The stator includes a stator core and a plurality of coils. The stator core includes an annular core back and a plurality of teeth arranged to extend radially inward from the core back. Each of the coils is wound around a separate one of the teeth. The coils include a plurality of main coils and a plurality of auxiliary coils. The main coils are defined by a continuous main conducting wire wound around every other tooth, with a direction of winding of the main conducting wire being reversed for each alternate coil. The auxiliary coils are defined by a continuous auxiliary conducting wire wound around each of the remaining teeth positioned between the alternate teeth, with a direction of winding of the auxiliary conducting wire being reversed for each remaining tooth. The stator core includes a collection of a plurality of core elements. Each of the core elements includes one of the teeth and a core back element, the core back element being a portion of the core back which corresponds to the one of the teeth. Adjacent ones of the core back elements are connected with each other at a radially outward joint portion and include mating surfaces arranged to be in contact with each other. The mating surfaces are defined by opposing side surfaces of the adjacent core back elements and are arranged radially inward of the joint portion. An area of the smallest of all cross-sections of each core back element taken along planes which are parallel or substantially parallel to an axial direction on either side of the tooth is arranged to be about 0.90 or more times an area of the smallest of all cross-sections of the tooth taken along planes which are parallel or substantially parallel to the axial direction.

Preferred embodiments of the present invention are able to prevent or minimize a decrease in efficiency of an operation of an induction motor including a main conducting wire and an auxiliary conducting wire.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a vertical cross-sectional view of a single-phase induction motor according to a preferred embodiment of the present invention.

FIG. 2 is a plan view of a stator according to the above preferred embodiment of the present invention.

FIG. 3 is a plan view of a stator core in an expanded condition according to the above preferred embodiment of the present invention.

FIG. 4 is an enlarged view of core elements according to the above preferred embodiment of the present invention.

FIG. 5 is an enlarged view of a joint portion and its vicinity according to the above preferred embodiment of the present invention.

FIG. 6 is a diagram illustrating how conducting wires are wound around teeth in a simplified form according to the above preferred embodiment of the present invention.

FIG. 7 is a plan view of a stator core according to another preferred embodiment of the present invention.

### DETAILED DESCRIPTION OF THE PREFERRED EMBODIMENTS

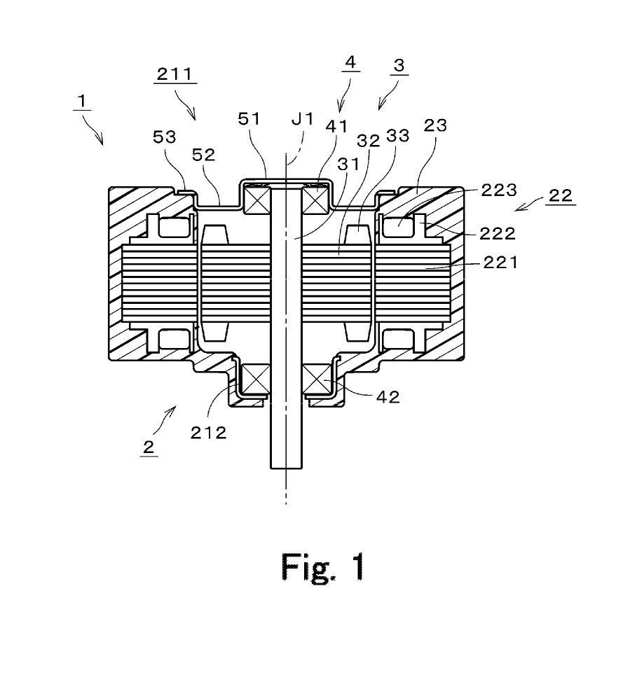

It is assumed herein that a vertical direction is defined as a direction in which a central axis J1 of a motor 1 extends, and that an upper side and a lower side along the central axis J1 in FIG. 1 are referred to simply as an upper side and a lower side, respectively. It should be noted, however, that the above definitions of the vertical direction and the upper and lower sides should not be construed to restrict relative positions or directions of different members or portions when the motor 1 is actually installed in a device. Also note that a direction parallel or substantially parallel to the central axis J1 is referred to by the term “axial direction”, “axial”, or “axially”, that radial directions centered on the central axis J1 are simply referred to by the term “radial direction”, “radial”, or “radially”, and that a circumferential direction about the central axis J1 is simply referred to by the term “circumferential direction”, “circumferential”, or “circumferentially”.

FIG. 1 is a vertical cross-sectional view of a single-phase induction motor 1 (hereinafter referred to as the “motor 1”) according to a preferred embodiment of the present invention. The motor 1 is preferably used in an air conditioner, an air purifier, a humidifier, a blower, or a fan, for example. The motor 1 is of an inner rotor type, and is arranged to rotate through input of a single-phase alternating current. The motor 1 includes a stationary portion 2, a rotating portion 3, and a bearing portion 4. The bearing portion 4 is arranged to support the rotating portion 3 such that the rotating portion 3 is rotatable about the central axis J1 with respect to the stationary portion 2. The bearing portion 4 preferably includes a first ball bearing 41 and a second ball bearing 42. The second ball bearing 42 is arranged below the first ball bearing 41.

The stationary portion 2 preferably includes a first bearing support portion 211, a second bearing support portion 212, a stator 22, and a resin mold 23. The resin mold 23 is preferably arranged to cover the entire stator 22 except for tip surfaces of teeth, that is, except for inner circumferential surfaces of the stator 22. The first bearing support portion 211 is preferably shaped by subjecting a plate material to a pressing process, however, any other desirable shaping process could be used instead. The first bearing support portion 211 preferably includes a central portion 51, a plate portion 52, and a flange portion 53. The central portion 51 is arranged substantially in the shape of a covered cylinder. The first ball bearing 41 is held inside the central portion 51. The plate portion 52 is arranged to extend radially outward from a lower end of the central portion 51 to assume an annular shape. The flange portion 53 is arranged to extend upward from an outer edge portion of the plate portion 52 and then extend radially outward to assume an annular shape. The flange portion 53 is fitted to the resin mold 23 while being in contact with both an inner circumferential surface and an upper surface of the resin mold 23.

The second bearing support portion 212 is shaped by subjecting a plate material to a pressing process. The second bearing support portion 212 includes a bottom and is substantially cylindrical, and includes an opening defined in a center of the bottom. The second bearing support portion 212 is preferably insert-molded with the resin mold 23 such that each of a lower surface and an outer circumferential surface of the second bearing support portion 212 is in contact with the resin mold 23. The second bearing support portion 212 is thus arranged inside the resin mold 23. The second ball bearing 42 is held by an inner circumferential surface of the second bearing support portion 212.

The stator 22 preferably includes a stator core 221, an insulator 222 made of, for example, a resin material, and a plurality of coils 223. Details of the stator 22 will be described below.

The rotating portion 3 preferably includes a shaft 31, a rotor core 32, and end rings 33. The shaft 31 is supported by the first and second ball bearings 41 and 42 such that the shaft 31 is rotatable about the central axis J1. An output end of the shaft 31 is arranged to project downward through the opening of the second bearing support portion 212. The rotor core 32 is defined by laminated steel sheets, and is arranged radially inside the stator 22. The end rings 33 are each preferably annular in shape, and are arranged on an upper surface and a lower surface of the rotor core 32. A plurality of spaces each extending in an axial direction are defined in the rotor core 32, and the spaces are arranged in a circumferential direction. Each of these spaces is preferably filled with a metal when the end rings 33 are molded by a die casting process, for example. The end rings 33 are connected with the metal filled into the spaces in the rotor core 32 such that a squirrel-cage rotor is defined. However, it should be noted that any other desirable type of rotor could be used instead of the squirrel-cage rotor.

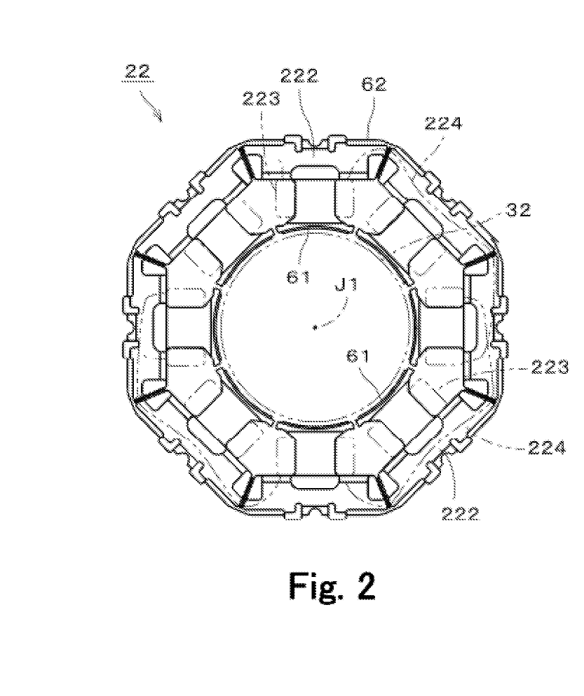

FIG. 2 is a plan view of the stator 22. In FIG. 2, the coils 223, passage lines 224, and the rotor core 32 are represented by chain double-dashed lines. The outside shape of the stator 22 is preferably substantially in the shape of an octagon centered on the central axis J1. The stator core 221 is preferably defined by laminated magnetic steel sheets each of which is in the shape of a thin plate, however, any other desirable type of stator core could be used. The entire stator core 221 is preferably covered by the insulator 222 except for an outer circumferential surface and inner circumferential surfaces thereof and their vicinities. The stator core 221 preferably includes, for example, eight teeth 61 and an annular core back 62. The teeth 61 are arranged to extend radially inward from the core back 62 toward the rotor core 32. Each of the coils 223 is preferably wound around a separate one of the teeth 61. In the stator 22, the coils 223 are preferably defined by a so-called concentrated winding method.

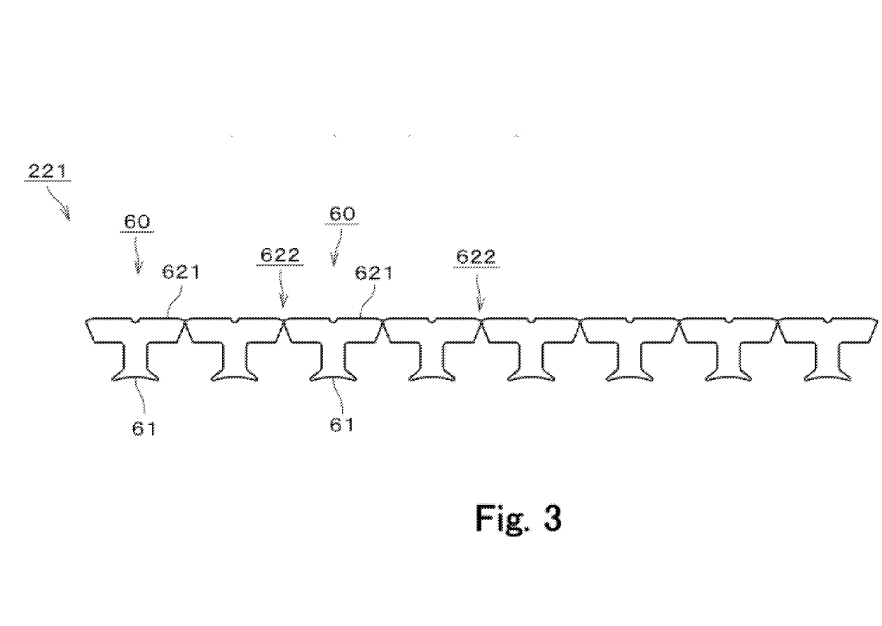

FIG. 3 is a plan view of the stator core 221 in an expanded condition. The stator core 221 preferably defined by a collection of a plurality of core elements 60. Each core element preferably includes one of the teeth 61 and a core back element 621. Each core back element 621 is a portion of the core back 62 which corresponds to one of the teeth 61, and defines an eighth portion of the core back 62. The core back element 621 is arranged to extend both to the left and to the right from a base of the tooth 61, and is substantially in the shape of a straight line.

Adjacent ones of the core back elements 621 are preferably connected with each other at a minute joint portion 622. The stator core 221 illustrated in FIG. 3 is bent at each joint portion 622 to define the stator core 221 into the annular shape. The core back elements 621 at both ends in FIG. 3 are preferably joined to each other by, for example, welding. Once the stator core 221 is arranged into the annular shape, the joint portions 622 are preferably positioned near a radially outermost portion of the core back elements 621 on both circumferential sides of each core back element 621. Note that, with respect to the core back element 621 of the core element 60 at either end, the joint portion 622 is arranged on only one circumferential side of the core back element 621.

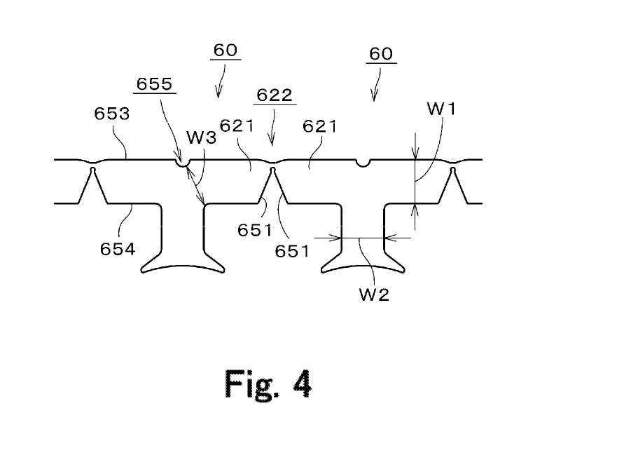

FIG. 4 is an enlarged view of the core elements 60. A lower side and an upper side in FIG. 4 will be hereinafter referred to as a radial inside and a radial outside, respectively. The same is true of other similar figures as well. Side surfaces 651 of each core back element 621 are positioned radially inward of the joint portions 622. The side surfaces 651 are sides of the core back element 621 on both right and left sides in FIG. 4, and each side surface 651 is opposed to an adjacent one of the core back elements 621. Once the stator core 221 is arranged into the annular shape, the opposing side surfaces 651 of adjacent ones of the core back elements 621 are substantially brought into contact with each other. Hereinafter, the side surfaces 651 will be referred to as “mating surfaces”. Each mating surface 651 is preferably a flat surface. A magnetic path in the core back 62 is defined as a result of contact between the mating surfaces 651. A radially outer surface 653 of each core back element 621, i.e., a surface of the core back element 621 on an opposite side to the tooth 61, will be hereinafter referred to as an “outer surface” 653. Radially inner surfaces 654 of each core back element 621, i.e., surfaces of the core back element 621 defined on a side where the tooth is arranged, will be hereinafter referred to as “inner surfaces” 654.

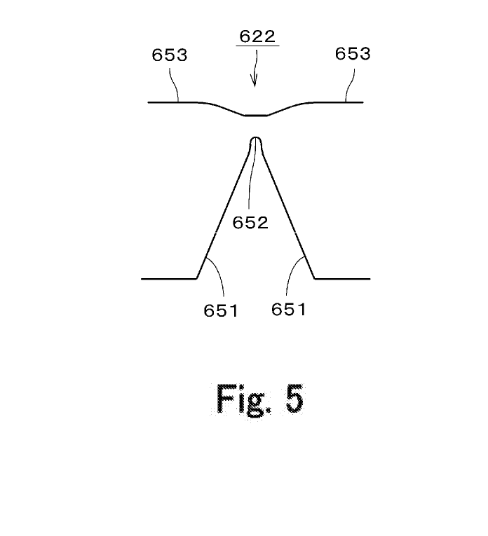

FIG. 5 is an enlarged view of the joint portion 622 and its vicinity. The outer surface 653 of each core back element 621, which are the surfaces of the core back element 621 defined on the opposite side to the tooth 61, preferably include a substantially flat surface which extends perpendicularly or substantially perpendicularly to a radial direction. More specifically, the outer surface 653 includes a substantially flat surface extending perpendicularly or substantially perpendicularly to the radial direction in the vicinity of a circumferential middle of the core back element 621, while in the vicinity of each joint portion 622, the outer surface 653 is arranged to slightly bend to the side on which the tooth 61 is arranged. A radially inner surface 652 of each joint portion 622 is preferably a minute cylindrical surface (more precisely, a portion of a minute cylindrical surface) extending in a thickness direction of the stator core 221 (i.e., in a radial direction). Accordingly, the radially inner surface 652 of the joint portion 622 will be hereinafter referred to as a “minute cylindrical surface” 652. Each mating surface 651 is arranged to extend from the minute cylindrical surface 652 to the side on which the tooth 61 is arranged. The minute cylindrical surface 652 and the mating surface 651 are smoothly joined to each other. Once the stator core 221 is arranged into the annular shape to bring the opposing mating surfaces 651 into contact with each other, each mating surface 651 extends in the radial direction.

The outer surface 653 of each core back element 621 is preferably arranged to be about 70% or more flat with respect to the circumferential direction, that is, with respect to a horizontal direction in FIG. 4 when the stator core 221 is in the expanded condition. A greater number of steel sheets defining the stator cores 221 can be obtained from a given amount of steel sheet material than in the case where the outer surface 653 is arranged to be cylindrical in its entirety. A flat surface of the outer surface 653 is preferably arranged to be perpendicular or substantially perpendicular to a direction in which the tooth 61 extends. Each inner surface 654 of the core back element 621 preferably includes a flat surface out on a separate circumferential side of the tooth 61. The steel sheets defining the stator cores 221 can thereby preferably be more efficiently obtained. Note that each inner surface 654 may not necessarily be flat in its entirety, but may, if so desired, include another surface in addition to the flat surface extending on the circumferential side of the tooth 61.

The outer surface 653 includes the flat surface extending substantially perpendicularly to the radial direction. Note that this flat surface may not necessarily extend exactly perpendicularly to the direction in which the tooth 61 extends. Also note that the outer surface 653 may not necessarily include a flat surface. Even in that case, if a portion of the outer surface 653 (especially, a portion of the outer surface 653 on an opposite side of the core back element 621 with respect to the tooth 61) is positioned radially inward of a cylindrical plane which is centered on the central axis J1 and which touches the stator core 221 at a radially outer point, efficiency in use of the steel sheet material when the steel sheet material is stamped by pressing, for example, is improved.

On either side of the tooth 61, the core back element 621 is preferably arranged to have a minimum radial width W1 equal to or greater than a minimum circumferential width W2 of the tooth 61. Here, to be precise, the radial width of the core back element 621 refers to the width of the core back element 621 measured in a substantially radial direction, i.e., the distance from a point on the outer surface 653 to the nearest point on the inner surface 654. In addition, the minimum radial width of the core back element 621 refers to a minimum radial width of the core back element 621 at a position which does not include any portion of any mating surface 651. To be precise, the minimum circumferential width of the tooth 61 refers to a minimum width of the tooth 61 measured in a direction perpendicular to both the central axis J1 of the stator 22 and a central axis of the tooth 61.

During driving of the single-phase induction motor of a concentrated winding type in accordance with a preferred embodiment of the present invention, the maximum magnetic flux passing through the tooth 61 and the maximum magnetic flux passing through the core back 62 are, in theory, sometimes equal to each other. Therefore, if the minimum width of the core back is smaller than the minimum width of the tooth, the magnetic flux may leak out of the core back. Also, each tooth will have a greater width than necessary compared with the width of the core back, and in the case where the single-phase induction motor is of the inner-rotor type, the stator core has to be increased in size in order to secure sufficient spaces for arrangement of the teeth. In contrast, in the case of the stator core 221 illustrated in FIG. 4, the minimum radial width (hereinafter referred to as a “minimum core back width”) W1 of the core back element 621 is preferably equal to or greater than the minimum circumferential width (hereinafter referred to as a “minimum tooth width”) W2 of the tooth 61. Therefore, the above problems do not occur easily. Note that leakage of the magnetic flux does not easily occur, either, when the minimum core back width W1 is about 0.90 or more times the minimum tooth width W2, for example. Moreover, the minimum core back width W1 is preferably about 2.00 or less times the minimum tooth width W2, for example, in order to avoid an excessive increase in the size of the stator core 221. Furthermore, when there is a demand for a reduction in the size of the motor, the minimum core back width W1 is preferably about 1.02 or less times the minimum tooth width W2, for example. For example, the minimum core back width W1 is preferably about 0.90 or more times the minimum tooth width W2 and about 1.02 or less times the minimum tooth width W2, or about 0.90 or more times the minimum tooth width W2 and about 2.00 or less times the minimum tooth width W2.

The above-described relationships between the minimum core back width W1 and the minimum tooth width W2 hold when the stator core 221 has a uniform thickness. In more general terms, leakage of the magnetic flux out of the core back 62 can be prevented or minimized when a minimum cross-sectional area of the core back element 621 is arranged to be equal to or greater than a minimum cross-sectional area of the tooth 61. A decrease in efficiency of an operation of the motor 1 can thereby be prevented or minimized. To be precise, the minimum cross-sectional area of the core back element 621 refers to the area of the smallest of all cross-sections of the core back element 621 taken along planes which are parallel or substantially parallel to the axial direction on either side of the tooth 61. Needless to say, cross-sections of the core back element 621 taken along planes which cross any mating surface 651 are excluded. In yet other terms, the minimum cross-sectional area of the core back element 621 refers to the area of the smallest of all cross-sections of the core back element 621 taken along planes which cross both the outer surface 653 and either inner surface 654 and which are parallel or substantially parallel to the axial direction. Meanwhile, to be precise, the minimum cross-sectional area of the tooth 61 refers to the area of the smallest of all cross-sections of the tooth 61 taken along planes which are parallel or substantially parallel to the axial direction and which cross both circumferential side surfaces of the tooth 61. The minimum cross-sectional area of the tooth 61 is normally the area of a cross-section of a portion of the tooth 61 around which a conducting wire is wound, the cross-section being perpendicular to the radial direction. In accordance with the above-described preferable ranges of the minimum core back width W1, the minimum cross-sectional area of the core back element 621 is preferably about 0.90 or more times the minimum cross-sectional area of the tooth 61 and about 1.02 or less times the minimum cross-sectional area of the tooth 61, or about 0.90 or more times the minimum cross-sectional area of the tooth 61 and about 2.00 or less times the minimum cross-sectional area of the tooth 61, for example.

Each core back element 621 preferably includes an axially extending groove 655 defined in the outer surface 653, which is the surface of the core back element 621 on the opposite side to the tooth 61. The groove 655 is preferably used to position the stator core 221 when the coil 223 is, for example, being wound on the tooth 61 by a winding machine. The shortest distance W3 between the groove 655 and each of the inner surfaces 654, which are surfaces of the core back element 621 which extend on both sides of the tooth 61, is preferably equal to or greater than the minimum circumferential width W2 of the tooth 61. Leakage of the magnetic flux is thereby preferably prevented or minimized at a junction of the tooth 61 and the core back element 621 as well. A decrease in the efficiency of the operation of the motor 1 is thereby prevented or minimized. The above-described relationship between the shortest distance W3 and the minimum tooth width W2 holds when the stator core 221 has a uniform thickness. In more general terms, leakage of the magnetic flux can be prevented or minimized when the area of the smallest of all cross-sections of the core back element 621 taken along planes which cross the groove 655 is arranged to be equal to or greater than the aforementioned minimum cross-sectional area of the tooth 61. A decrease in the efficiency of the operation of the motor 1 can thereby preferably be prevented or minimized. Note that, to be precise, the aforementioned area of the smallest cross-section of the core back element 621 refers to the area of the smallest of all cross-sections of the core back element 621 taken along planes which are parallel or substantially parallel to the axial direction and which cross both the groove 655 and either inner surface 654.

In the stator core 221, the length of each mating surface 651 in a plan view is preferably equal to or greater than the circumferential width W2 of each tooth 61. The range of the mating surface 651 is a range over which the mating surface 651 is substantially in contact with an opposing one of the mating surfaces 651 when the stator core 221 is arranged in the annular shape. In the case where the mating surface 651 is inclined with respect to the radial direction when the stator core 221 is arranged in the annular shape, the length of the mating surface 651 is assumed to refer to the length of the mating surface 651 projected on a plane passing through a center of the mating surface 651 and the central axis J1 and extending in the radial direction. The core back 62 is preferably arranged so that the length of each mating surface 651 is equal to or greater than the minimum tooth width W2, in order to prevent or minimize leakage of the magnetic flux through the mating surface 651.

The above-described relationship between the length of each mating surface 651 and the minimum tooth width W2 also holds when the stator core 221 has a uniform thickness. In more general terms, leakage of the magnetic flux through the mating surface 651 can be prevented or minimized when the area of the mating surface 651 is arranged to be equal to or greater than the above-described minimum cross-sectional area of each tooth 61. In the case where the mating surface 651 is inclined with respect to the radial direction when the stator core 221 is arranged in the annular shape, the area of the mating surface 651 is assumed to refer to the area of the mating surface 651 projected on the plane passing through the center of the mating surface 651 and the central axis J1 and extending in the radial direction. Note that, in the case where each core back element 621 is in the shape of a straight line, the minimum cross-sectional area of the core back element 621 may be greater than the area of each mating surface 651, and also may be smaller than the area of each mating surface 651. In particular, in the case where each inner surface 654 is a portion of a cylindrical surface centered on the central axis J1 unlike in the case of FIG. 4, there is a high likelihood that the minimum cross-sectional area of the core back element 621 is smaller than the area of the mating surface 651.

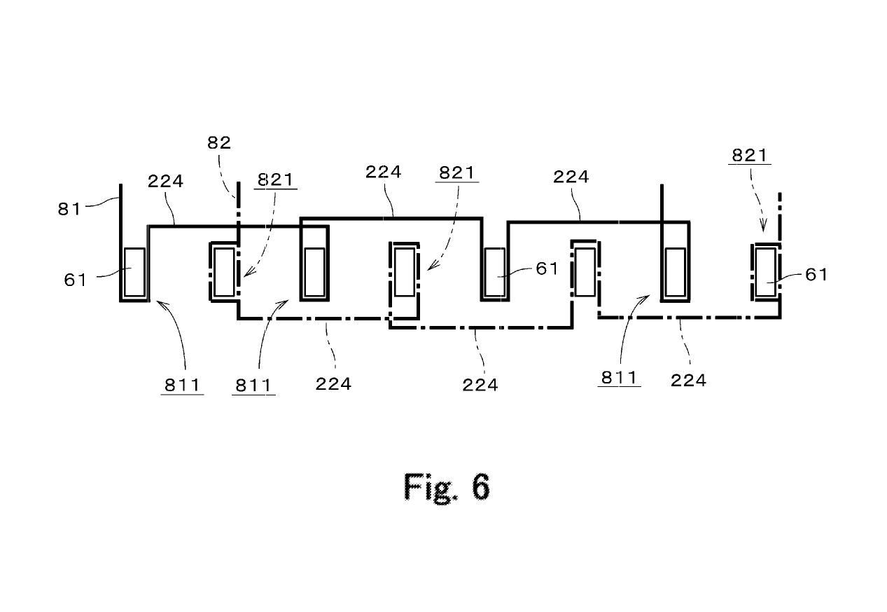

FIG. 6 is a diagram illustrating in a simplified form how conducting wires are preferably wound around the eight teeth 61. The thick solid line represents a main conducting wire 81 while the thick dot-dashed line represents an auxiliary conducting wire 82. Note that illustration of how each of the main conducting wire 81 and the auxiliary conducting wire 82 is wound around each tooth 61 multiple times to define the coil 223 has been omitted for the sake of clarity. Each of the main conducting wire 81 and the auxiliary conducting wire 82 is a preferably a continuous conducting wire. A plurality of main coils 811 are defined by winding the main conducting wire 81, i.e., a continuous conducting wire, around every other tooth 61 while reversing the direction of winding of the main conducting wire 81 for each alternate tooth 61. The auxiliary conducting wire 82, i.e., a continuous conducting wire, is wound around the remaining teeth 61, which are positioned between the alternate teeth 61 around which the main coils 811 are defined, while the direction of winding of the auxiliary conducting wire 82 is reversed for each remaining tooth 61. As a result, a plurality of auxiliary coils 821 are defined. That is, each main coil 811 is defined by a portion of the main conducting wire 81, while each auxiliary coil 821 is defined by a portion of the auxiliary conducting wire 82.

It is assumed here that the direction of winding of each of the main conducting wire 81 and the auxiliary conducting wire 82 refers to the direction of winding when the tooth 61 is viewed from the direction of the central axis J1. Note that each of the main conducting wire 81 and the auxiliary conducting wire 82 may be defined by a plurality of cut conducting wires joined to each other to provide a continuous conducting wire, if so desired.

Each of the main conducting wire 81 and the auxiliary conducting wire 82 is preferably wound around every other tooth in due order along the circumferential direction. Passage lines 224 of the main conducting wire 81 which extend between the teeth 61 are arranged on the upper side in FIG. 1, whereas passage lines 224 of the auxiliary conducting wire 82 which extend between the teeth 61 are arranged on the lower side in FIG. 1. The passage lines 224 illustrated in FIG. 2 are the passage lines 224 of the main conducting wire 81.

Note that the passage lines 224 of the main conducting wire 81 may be arranged on the lower side, with the passage lines 224 of the auxiliary conducting wire 82 being arranged on the upper side. In short, the passage lines 224 of the main conducting wire 81 are arranged on one of the upper and lower sides of the core back 62, while the passage lines 224 of the auxiliary conducting wire 82 are arranged on the other one of the upper and lower sides of the core back 62. Interference of the main conducting wire 81 with the auxiliary conducting wire 82 at any passage line 224 is thus prevented. The passage lines 224 on the lower side of the stator 22 are preferably arranged in a manner substantially similar to that of the passage lines 224 on the upper side of the stator 22 as illustrated in FIG. 2.

Like a common single-phase induction motor, the motor 1 preferably includes a capacitor, and the capacitor is used to cause an alternating current that flows in the main conducting wire 81 and an alternating current that flows in the auxiliary conducting wire 82 to be 90 degrees or about 90 degrees out of phase with each other. A rotating magnetic field is thereby generated inside the stator 22, so that the rotating portion 3 is caused to rotate.

While preferred embodiments of the present invention have been described above, it is to be understood that the present invention is not limited to the above-described preferred embodiments.

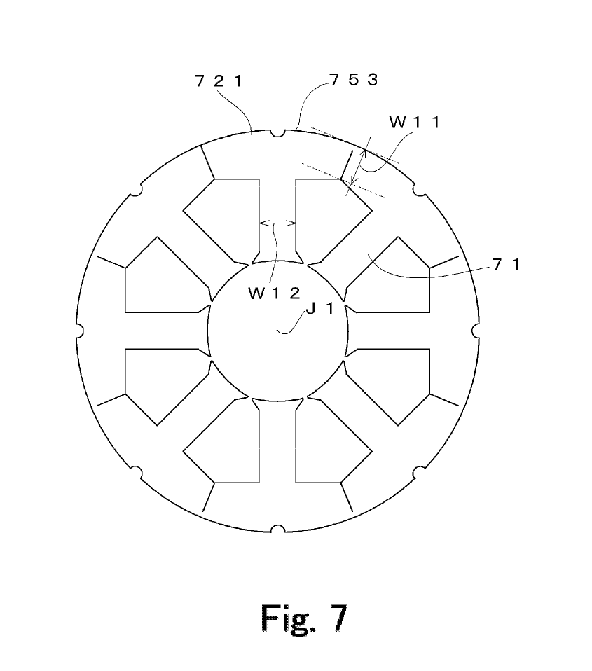

For example, referring to FIG. 7, an entire outer surface 753 may be defined by a portion of a cylindrical surface centered on the central axis J1 according to a modification of the above-described preferred embodiment. In this case, however, the efficiency in the use of the steel sheet material is lower than in the case where the outer surface 753 has the shape according to the above-described preferred embodiment. Also in this case, leakage of the magnetic flux can be prevented or minimized, and a decrease in the efficiency of the operation of the motor can be prevented or minimized, when each of core back elements 721 is arranged to have a minimum width W11 equal to or greater than a minimum width W12 of each of teeth 71 in the case where the stator core has a uniform thickness. Note that also when the minimum width (hereinafter referred to as a “minimum core back width”) W11 of the core back element is about 0.90 or more times the minimum width (hereinafter referred to as a “minimum tooth width”) W12 of the tooth 71, the likelihood that leakage of the magnetic flux will occur is low. The minimum core back width W11 is preferably about 2.00 or less times the minimum tooth width W12 in order to avoid an excessive increase in the size of the stator core. Moreover, when there is a demand for a reduced size of the motor, the minimum core back width W11 is preferably about 1.02 or less times the minimum tooth width W12. For example, the minimum core back width W11 is preferably about 0.90 or more times the minimum tooth width W12 and about 1.02 or less times the minimum tooth width W12, or about 0.90 or more times the minimum tooth width W12 and about 2.00 or less times the minimum tooth width W12. In more general terms, a minimum cross-sectional area of the core back element 721 is preferably about 0.90 or more times a minimum cross-sectional area of the tooth 71 and about 1.02 or less times the minimum cross-sectional area of the tooth 71, or about 0.90 or more times the minimum cross-sectional area of the tooth 71 and about 2.00 or less times the minimum cross-sectional area of the tooth 71, for example. To be precise, the minimum cross-sectional area of the core back element 721 refers to the area of the smallest of all cross-sections of the core back element 721 taken along planes which are parallel or substantially parallel to the axial direction on either side of the tooth 71. Meanwhile, to be precise, the minimum cross-sectional area of the tooth 71 refers to the area of the smallest of all cross-sections of the tooth taken along planes which are parallel or substantially parallel to the axial direction and which cross both circumferential side surfaces of the tooth 71. Note that the number of core elements 60 may be, for example, twelve or even more if so desired. In the case of the single-phase induction motor, in principle, the number of core elements 60 is preferably a multiple of four, for example. The efficiency in the use of the steel sheet material is particularly improved when the outer surface 653 of each core back element 621 is arranged to be substantially flat in the case where the number of core elements 60 is eight or twelve. Note that the outer surface 653 of the core back element 621 may alternatively be covered with a motor housing instead of the resin mold if so desired.

Also note that the bearing portion 4 is not limited to the ball bearings 41 and 42. For example, a bearing portion in the shape of a sleeve may be used as the bearing portion 4.

Features of the above-described preferred embodiments and the modifications thereof may be combined appropriately as long as no conflict arises.

Various preferred embodiments of the present invention are applicable to motors used for a variety of applications. In particular, the present invention is suitably applicable to motors for use in, for example, an air conditioner, an air purifier, a humidifier, a blower, and a fan.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A single-phase induction motor comprising:
a rotating portion;
a stationary portion including a stator; and
a bearing portion arranged to support the rotating portion such that the rotating portion is rotatable about a central axis with respect to the stationary portion; wherein
the stator includes:
a stator core including an annular core back and a plurality of teeth arranged to extend radially inward from the core back; and
a plurality of coils each of which is wound around a separate one of the teeth;
the plurality of coils include:
a plurality of main coils defined by a continuous main conducting wire wound around every other one of the teeth, with a direction of winding of the main conducting wire being reversed for each alternate coil; and
a plurality of auxiliary coils defined by a continuous auxiliary conducting wire wound around each of the remaining teeth positioned between the alternate teeth, with a direction of winding of the auxiliary conducting wire being reversed for each remaining tooth;
the stator core includes a plurality of core elements;
each of the plurality of core elements includes one of the teeth and a core back element, the core back element being a portion of the core back which corresponds to the one of the teeth;
adjacent ones of the core back elements are connected with each other at a radially outward joint portion, and include mating surfaces arranged to be in contact with each other, the mating surfaces being opposing side surfaces of the adjacent core back elements and being arranged radially inward of the joint portion; and
an area of a smallest of all cross-sections of each core back element taken along planes which are parallel or substantially parallel to an axial direction on either side of the one of the teeth is about 0.90 or more times an area of a smallest of all cross-sections of the one of the teeth taken along planes which are parallel or substantially parallel to the axial direction.

2. The single-phase induction motor according to claim 1, wherein the area of the smallest of all cross-sections of each core back element taken along the planes which are parallel or substantially parallel to the axial direction on either side of the one of the teeth is equal to or greater than the area of the smallest of all cross-sections of the one of the teeth taken along the planes which are parallel or substantially parallel to the axial direction.

3. The single-phase induction motor according to claim 1, wherein the area of the smallest of all cross-sections of each core back element taken along the planes which are parallel or substantially parallel to the axial direction on either side of the one of the teeth is about 2.00 or less times the area of the smallest of all cross-sections of the one of the teeth taken along the planes which are parallel or substantially parallel to the axial direction.

4. The single-phase induction motor according to claim 2, wherein the area of the smallest of all cross-sections of each core back element taken along the planes which are parallel or substantially parallel to the axial direction on either side of the one of the teeth is about 2.00 or less times the area of the smallest of all cross-sections of the one of the teeth taken along the planes which are parallel or substantially parallel to the axial direction.

5. The single-phase induction motor according to claim 3, wherein the area of the smallest of all cross-sections of each core back element taken along the planes which are parallel or substantially parallel to the axial direction on either side of the one of the teeth is about 1.02 or less times the area of the smallest of all cross-sections of the one of the teeth taken along the planes which are parallel or substantially parallel to the axial direction.

6. The single-phase induction motor according to claim 4, wherein the area of the smallest of all cross-sections of each core back element taken along the planes which are parallel or substantially parallel to the axial direction on either side of the one of the teeth is about 1.02 or less times the area of the smallest of all cross-sections of the one of the teeth taken along the planes which are parallel or substantially parallel to the axial direction.

7. The single-phase induction motor according to claim 3, wherein an area of each mating surface is equal to or greater than the area of the smallest of all cross-sections of the one of the teeth taken along the planes which are parallel or substantially parallel to the axial direction.

8. The single-phase induction motor according to claim 3, wherein
each core back element includes inner surfaces defined on a side where the one of the teeth is arranged, and an outer surface defined on an opposite side to the one of the teeth;
the outer surface includes a groove extending in the axial direction; and
an area of the smallest of all cross-sections of the core back element taken along planes which are parallel or substantially parallel to the axial direction and which cross both the groove and either inner surface is equal to or greater than the area of the smallest of all cross-sections of the one of the teeth taken along the planes which are parallel or substantially parallel to the axial direction.

9. The single-phase induction motor according to claim 7, wherein
each core back element includes inner surfaces defined on a side where the one of the teeth is arranged, and an outer surface defined on an opposite side to the one of the teeth;
the outer surface includes a groove extending in the axial direction; and
an area of the smallest of all cross-sections of the core back element taken along planes which are parallel or substantially parallel to the axial direction and which cross both the groove and either inner surface is arranged to be equal to or greater than the area of the smallest of all cross-sections of the one of the teeth taken along the planes which are parallel or substantially parallel to the axial direction.

10. The single-phase induction motor according to claim 3, wherein passage lines of the main conducting wire are arranged on one of upper and lower sides of the core back, whereas passage lines of the auxiliary conducting wire are arranged on the other one of the upper and lower sides of the core back.

11. The single-phase induction motor according to claim 3, wherein each core back element includes an outer surface defined on an opposite side to the one of the teeth, the outer surface including a flat surface extending perpendicularly or substantially perpendicularly to a radial direction.

12. The single-phase induction motor according to claim 3, wherein each core back element includes an outer surface defined on an opposite side to the one of the teeth, the outer surface including a portion positioned radially inward of a cylindrical plane which is centered on the central axis and which touches the stator core at a radially outer point.

13. The single-phase induction motor according to claim 11, wherein the number of core elements is eight or twelve.

14. The single-phase induction motor according to claim 12, wherein the number of core elements is eight or twelve.

15. The single-phase induction motor according to claim 3, wherein the single-phase induction motor has a structure that is adapted for use in an air conditioner, an air purifier, a humidifier, a blower, or a fan.
